(19) United States
(12) Patent Application Publication
(10) Pub. No.: US 2013/0173476 A1
(43) Pub. Date: Jul. 4, 2013

(54) Computer system and method for initiating payments based on cheques

(71) Applicant: Barclays Bank PLC, London (GB)

(72) Inventors: Ian Sayers, Cheshire (GB); Dermot Dwyer, High Peak (GB); Darren Foulds, Hampshire (GB); Paul Geoffrey Maddox, Surrey (GB)

(73) Assignee: BARCLAYS BANK PLC, London (GB)

(21) Appl. No.: 13/677,505

(22) Filed: Nov. 15, 2012

(30) Foreign Application Priority Data
Jan. 4, 2012 (EP) 12000048.4

(51) Int. Cl. G06Q 20/04; G06Q 20/10

(52) U.S. Cl. CPC G06Q 20/042; G06Q 20/409; G06Q 20/10
USPC 705/71; 235/379; 705/39; 705/44

(57) ABSTRACT

A system and method for initiating electronic payments based on paper cheques, including a paying party chip-and-PIN terminal arranged to input cleartext data including a cheque number and an amount from a cheque issued by a first bank, at which the paying party has an account, and generating from it encoded data using a key, for the user to write on the cheque; and a computer associated with the first bank, arranged to accept, from a paid party via the internet, data defining a second bank and an account at the second bank, associated with the paid party; accepting, from the paid party, the cleartext data and the encoded data from the cheque, and validating the cleartext data from the cheque using the encoded data and the key; and initiating an electronic funds transfer from the first bank to the second bank of the amount specified on the cheque.

### FIELD OF THE INVENTION

This invention relates to initiating computerized payments based on cheques.

### BACKGROUND OF THE INVENTION

In conventional cheque payment systems, a user (that is, drawer, paying party, payer or other similar terms as used herein) is issued a book of paper cheques by his bank (that is, the cheque issuing bank, drawee, paying bank, payer bank or other similar terms as used herein). Each cheque is printed with the name and number of the user's account, the name and sort code of his bank, and an individual cheque number.

When the user writes a cheque to a receiving party (payee, paid party or other similar terms as used herein), he includes the date, the amount, and the name of receiving party, and signs the cheque. It was formerly common to write, on the back of the cheque, the numbers of the user's cheque guarantee card, which guaranteed payment up to a certain limit, but such cards have now been largely replaced by debit and other cards.

The receiving party then brings the cheque to his own (or another) bank (the “collecting bank”), which passes the cheque back to the issuing bank. At the issuing bank, the signature and, when present, the cheque guarantee card number are checked. If funds are available, the issuing bank transfers the requested amount to the receiving bank, for the account of the payee. If not, the transaction is not honoured, the cheque is returned to the drawer, and the collecting bank, and hence the receiving party, are notified.

In some countries, such as England and Scotland, a trusted central clearing house (Inter Bank Data Exchange, “IBDE”, operated by the Cheque and Credit Clearing Company, “C&CCC”) can perform some of the processing on behalf of the banks, but generally physical movement of the cheques to the drawee bank is still required. The authentication of a cheque payment is required towards the end of the process, that is, when the ‘pay/no-pay’ decision is made by the issuing bank. This is in contrast with most other types of payment.

Such systems are therefore comparatively expensive to operate for both the bank of the paying party and that of the receiving party. However, they have proved popular with customers, who are reluctant to replace them with other systems, in particular because they require little effort on behalf of the paying party, who merely needs to identify the payee by name.

It is known from U.S. Pat. No. 7,360,081-A to Pretorius (“Pretorius” (and indeed generally) to authenticate an item by encrypting data relating to the item. At Col. 6, lines 17-31, of the '081 patent, it is proposed to use cheque data “such as data relating to the Drawer bank, the date, the amount, the Drawer, account number and branch code number” to validate a cheque, by generating “an encrypted code . . . applied in human or machine perceivable form . . . on the cheque.” However, Pretorius does not explain how such validation is used. It would presumably be used at the paying bank, once the cheque had been passed back to it from the receiving bank, as an additional level of security over use of the paying party's signature alone.

### SUMMARY OF THE INVENTION

Rather than replacing paper cheques, the present invention is therefore intended to provide a computer system for initiation of rapid and secure computerized electronic transactions based on paper cheques. The present invention also leaves it open, to the payee, to present the cheques by conventional means.

In a preferred embodiment, the system includes a paying party terminal arranged to input cleartext data from a cheque issued by a first bank, at which the paying party has an account, and generating therefrom encoded data using a key. A computer is associated with the first bank. The computer system accepts from a paid party, data defining a second bank and an account there associated with the paid party. The computer further accepts, from the paid party, the cleartext data from the cheque and the encoded data, and validates the cleartext data from the cheque using the encoded data and the key. The computer arranges a transfer from the first bank to the second bank of the amount specified on the cheque

Thus, due to the encoded data, the first bank (that of the payer) is able to accept a payment instruction from the paid party to transfer funds to a second bank (that of the paid party), without the need to physically pass the cheque through the second bank and then back to the first bank before the transaction can occur.

This system has a number of advantages. Firstly, the first bank can check whether funds are available immediately, before any data is presented to the second bank, so there is no need to rollback transactions there if the cheque bounces for insufficient funds. Secondly, since all the conventional cheque data can be present, the paid party is still able to present the cheque physically to his own bank for conventional processing if so required. Thirdly, the paying party is able to continue to write a paper cheque as before, without the need to identify full details of the paid party's bank account which would be necessary if he were to attempt an online electronic interbank payment direct from his account to that of the paid party.

Preferably, the paying party terminal is a chip-and-PIN card reader of a type which is familiar to the user, so that the user's card number and PIN (known also to his bank) present a high level of authentication of the user, whilst feeling familiar.

Preferably, the paying party writes the encoded data onto the cheque and the paid party reads it therefrom.

Preferably, the cheque data to be input includes the payment amount, so that the paying party is secured against attempts by others (including the paid party) to alter the cheque amount because the computer can validate the amount using the same PIN and key as at the paying party terminal.

Preferably, the cheque data to be input includes the cheque number. Since each cheque is uniquely numbered, this means that the encoded data generated will be different (in an unpredictable way) for each cheque, even if the amount, date, and parties are identical. Thus, it is not possible for a paid party to fraudulently re-enter the same data twice, pretending that there are two cheques in the same amount. Both the payment amount and the cheque number are numeric and can therefore be entered in a standard chip-and-PIN-type device without requiring an alphanumeric keyboard.

Preferably, the computer is provided with a web server interface to allow the paid party to communicate electronically, very preferably using a secure connection such as an HTTPs connection, via a computer or mobile terminal such as a tablet or phone.

In one embodiment, the first bank is arranged to check whether the drawer and the payee have had any previous transactions. If not, the payee cannot use electronic payment, but can present the cheque for payment at a bank in conventional fashion. As many cheque payments are repeat transactions (birthday gifts to family members, or payments of utility bills) there is a greater likelihood that the bearer of the cheque is the intended payee. Preferably, the records held by the bank are updated so that next time the payee requests payment from the same person, the payment will be validated and made to the payee.

It will be seen that in this embodiment, the invention allows the paid party to instruct the paying party's bank to transfer funds, without him needing a bank account there.

In yet another aspect, there is provided a computer program arranged to configure a computer system as the system described above.

In other aspects, there is provided a method of operating a payment instrument system as described above. In another aspect, there is provided a computer program arranged to carry out the method when executed by suitable programmable devices.

### BRIEF DESCRIPTION OF THE DRAWINGS

Embodiments of the invention will now be illustrated, by way of example only, with reference to the accompanying drawings in which:

FIG. 1 is a block diagram showing the main components of a payment system according to a first embodiment of the invention;

FIG. 2 is a block diagram showing the main components of a card reader comprising part of the system of FIG. 1 according to the first embodiment of the invention;

FIG. 3 shows a cheque used in the embodiment of the invention as shown in FIG. 1;

FIG. 4a is a flow diagram illustrating the main processing steps performed by the card reader of FIG. 2 in a first embodiment of the invention;

FIG. 4b is a flow diagram illustrating the main processing steps performed by a web server computer system comprising part of the system of FIG. 1 in the first embodiment of the invention;

FIG. 4c is a flow diagram illustrating the main processing steps performed by a bank computer system comprising part of the system of FIG. 1 in the first embodiment of the invention;

FIG. 5 corresponds to FIG. 4c and shows the main processing steps performed by a bank computer system comprising part of the system of FIG. 1 in a second embodiment of the invention;

FIG. 6 corresponds to FIG. 4c and shows the main processing steps performed by a bank computer system comprising part of the system of FIG. 1 in a third embodiment of the invention; and

FIG. 7 is a block diagram showing the main components of a computer suitable for use in the system of FIG. 1 in implementing all of the above embodiments.

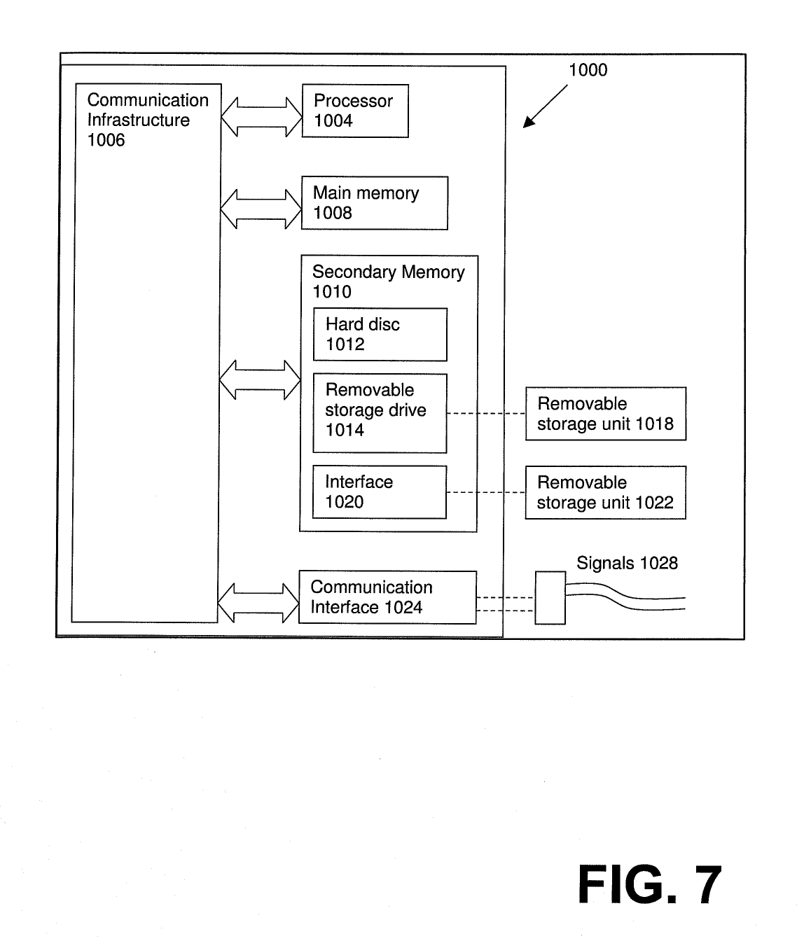

### DETAILED DESCRIPTION OF EMBODIMENTS OF THE INVENTION

### First Embodiment

### System Architecture

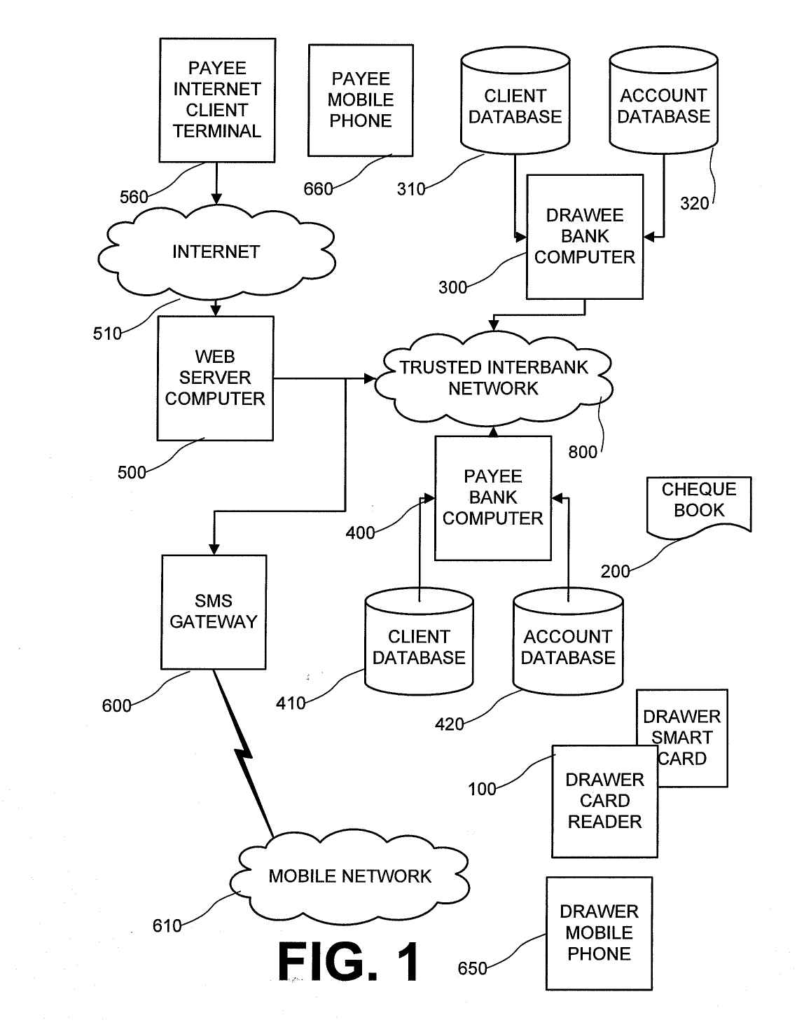

FIG. 1 shows the overall system in accordance with a preferred embodiment. A user has a personal card reader system 100 and a cheque book 200 comprising a plurality of sequentially numbered cheques. Briefly, and as will be fully appreciated based upon the following disclosure, a computerized payment system for initiating electronic payments based on paper cheques is disclosed. The system includes an issuing bank having a first bank computer system 300. The first bank computer system 300 includes a client database 310 and an account database 320. The system also includes a payee bank having a second bank computer system 400, the second bank computer system 400 also including a client database 410 and an account database 420. A web server payment computer 500 is in communication with the first bank computer system 300 and the second bank computer system 400. The system also includes a drawer card reader system 100 including a smart card 1 and a card reader 2, wherein upon writing a cheque 201 to a paid party the paying party inserts the smart card 1 into the card reader 2 and proceeds through an authentication process and a response is generated by the drawer card reader system 100, the response being written on the cheque 201. The system also includes a payee internet client terminal 560 in communication with the web server payment computer 500, wherein upon the payee internet client terminal 560 uploading data and the response from the cheque 201 to the web server payment computer 500, the first bank computer system 300 determines if the cheque 201 is valid and causes the issuing bank to initiate an electronic transfer of funds to the payee bank if the cheque 201 is confirmed as valid.

A first bank (which in this embodiment is the issuing or drawee bank) has a computer system, that is, a first bank computer system, 300 comprising a client database 310 holding records comprising, for each user, the user's name and address; the user's account number(s) and name(s) the user holds; the sort code of his branch; and information identifying a personal chip card held by the user. It also holds an account database 320 detailing, for each account, the current balance; the cheque numbers issued to the user; and other credit and historical data of the user.

A second bank (which in this embodiment is the payee bank) likewise has a computer system, that is, a second bank computer system, 400 comprising similar client databases 410 and account databases 420, respectively.

A web server payment computer 500 provides a person-to-person or peer-to-peer (usually abbreviated as P2P) payment system similar to the American Express™ digital payment and commerce platform called Serve™ or that offered by Visa™, or those offered by numerous other payment processing companies including the PopMoney™ system from CashEdge Inc. and the QuickPay™ system from JP Morgan Chase™, accessible via the Internet 510 from a payee internet client terminal, such as, a computer, smartphone or tablet, 560. Another example is the system described by the present applicant in PCT published application No. PCT/GB2011/052367 filed on 30 Nov. 2011.

An SMS gateway 600 is arranged to receive messages, from computers with a designation of a destination mobile telephone, and send each as an SMS message to the designated mobile telephone via a mobile network 610 (which may be comprised of a number of separately owned networks via which a message may be passed). The message-enabled telephone (e.g. mobile phone) of the payer is designated 650 and the mobile phone of the payee is designated 660 hereafter.

The web server payment computer 500 is connected to the SMS gateway 600 and to the first bank computer system 300 (Drawee Bank Computer) and the second bank computer system 400 (Payee Bank Computer), and those two bank computer systems are interconnected to each other by secure electronic communications channels making up a Trusted Interbank Communications Network 800 currently used for clearing and other electronic payment systems as is well known in the art.

The hardware of the drawer card reader system 100, in a preferred embodiment, is that of a standard online banking authentication device. Examples of authentication devices are the PINSentry™ device supplied by Barclays Bank, the present applicant, or the Card-Reader device supplied by Natwest Bank. Some aspects of the former are described in the applicant's earlier PCT Publication No. WO 2007/096590. Such a device complies with the Chip Authentication Programme (CAP) described in “Optimised to Fail: Card Readers for Online Banking”, Saar Drimer, Steven J. Murdoch, and Ross Anderson, Financial Cryptography and Data Security '09, Barbados, February 2009. Springer LNCS, itself based on the public EMV (Europay, MasterCard, Visa) chip-and-PIN payment standard.

### Card Reader System 100

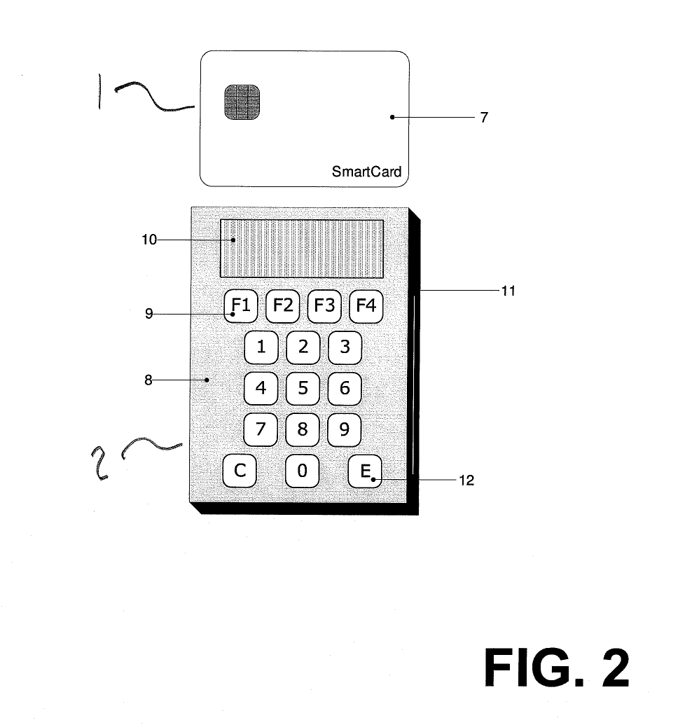

FIG. 2 shows the details of the terminal used by the paying party, that is, a paying party (or drawer) terminal. In accordance with a preferred embodiment, the paying party terminal is a drawer card reader system 100. The drawer card reader system 100 consists of a smart card 1 and a card reader 2. The card reader 2 includes a numeric keypad 8, identify respond and sign keys 9, designated F1, F2, F3, and F4, an enter key 12 for confirming entries, a display 10 for displaying messages and echoing key presses, and a smart card reader slot 11. Any smart card 1 conforming to the relevant standards (such as ISO-7816 or EMV) can be inserted into the smartcard reader slot 11 by the user. The smart card 1 includes contacts 7 for electrical connection to corresponding contacts within the slot 11, although a contactless connection may be used instead. The smart card 1 carries a processor and secure storage of data including the user's Personal Identification Number (PIN).

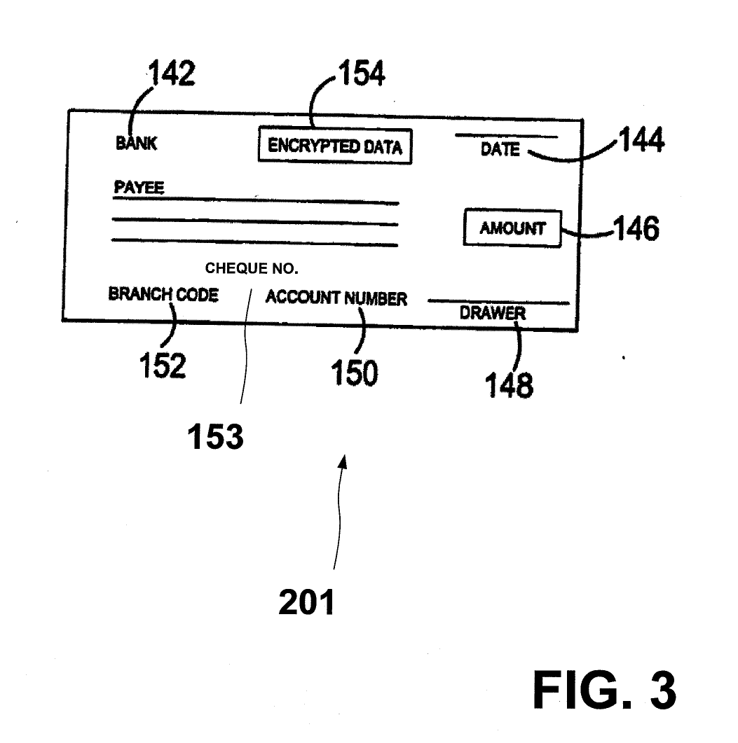

FIG. 3 shows schematically a cheque 201 according to the present embodiment. A cheque 201 is a printed paper document carrying pre-printed data relating to the drawer bank 142, the drawer 148, the account number 150 and the branch code (sort code) number 152. These data are common to all the cheques in the cheque book 200. The cheque 201 also carries a printed unique sequential cheque number 153. These data are also reproduced in a machine-readable font at the bottom of the cheque 201. In the United Kingdom cheques conform to “Cheque and Credit Clearing Company “Standard 3”, the industry standard detailing layout and font (with which FIG. 3 is not intended to accurately comply). It is appreciated the standards of other countries may be used in implementing the present invention.

The cheque 201 has spaces for entry by the drawer of the date 144, the amount 146, and the name of the payee 140. Finally, the cheque 201 has space 154 for manual entry by the drawer of a code described in further detail below. In a preferred embodiment, no printed space for this is provided on the cheque 201 and it is instead simply written on the rear of the cheque.

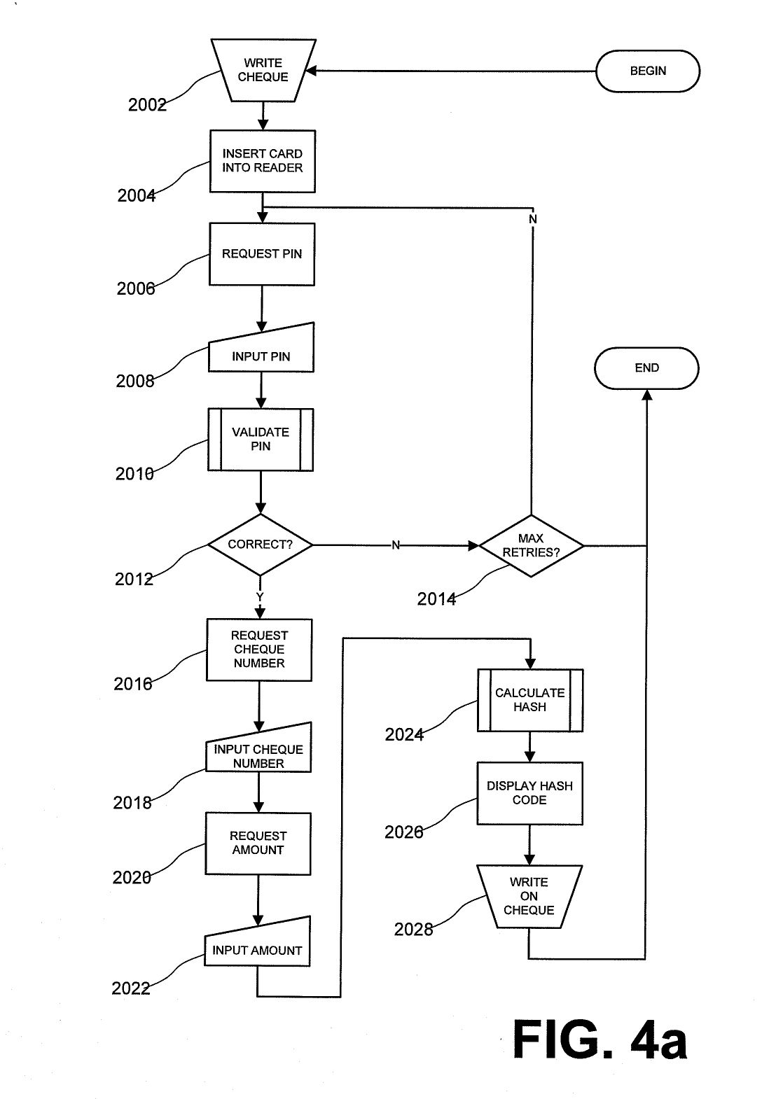

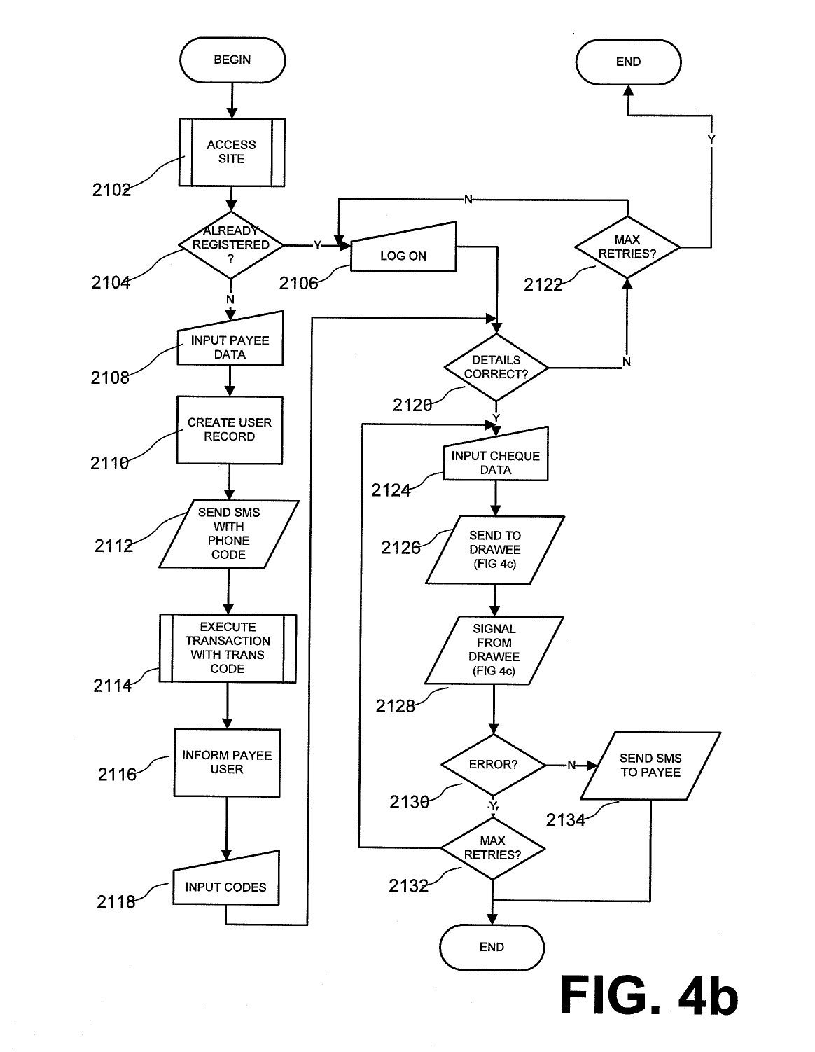

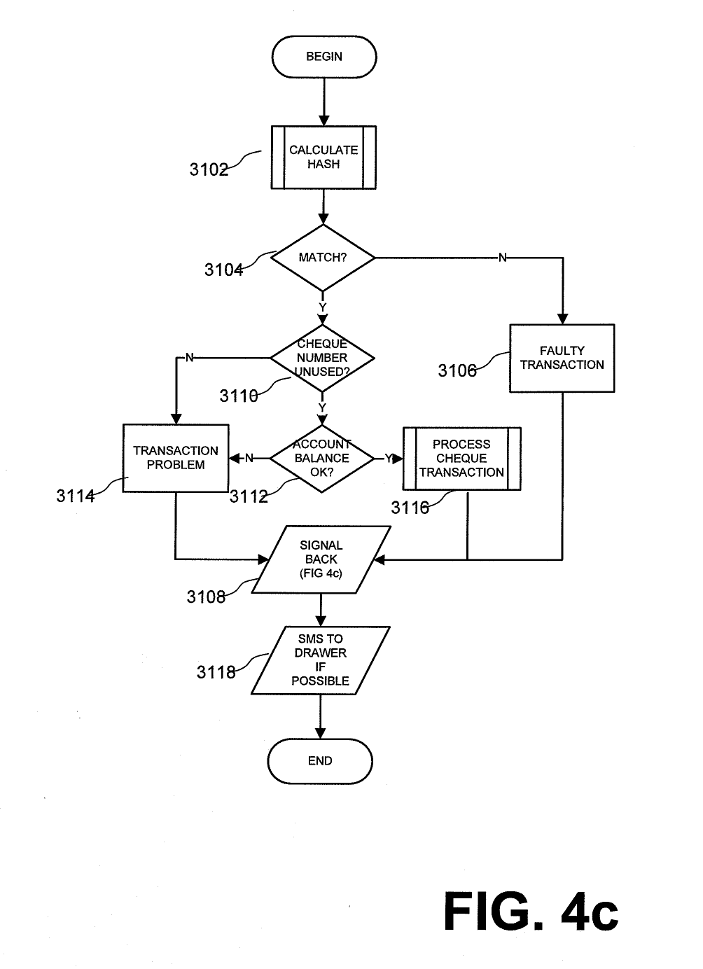

The process performed by the card reader system 100 will now be described with reference to FIG. 4a. In the first step 2002, the user writes a cheque 201 to the payee. In the next step 2004, the user inserts his smart card 1 into the card reader 2 and the reader and card exchange data in conventional fashion. In step 2006, the card reader 2 displays a challenge: “Enter PIN”. In the next step 2008, the user presses the “Sign” key and enters his PIN. In the next step 2010, the smart card 1 compares the PIN to that it has stored. If they do not match (step 2012), until the maximum number of incorrect entries, of the PIN, is attempted (step 2014), the user is requested to re-enter the PIN. When a match is found (step 2012), the user is authenticated as the correct user of the card. These steps 2004-2014 are performed, exactly as is known by those skilled in the art for online banking cards according to the CPA protocol.

The smart card 1 then executes a cheque security application. In the next step 2016, the smart card causes the card reader 2 to display a prompt to “Enter Reference Number”. The user enters the cheque number in response. In the next step 2018, the smart card 1 causes the card reader 2 to display a prompt to “Enter Amount”. Again, the user does so. The smart card 1 then calculates (step 2024) from these two numbers (which collectively are the basis of the “challenge”) a “response” which is a hash or digital signature function of the challenge, using a stored encryption key. The response may, for example, be 8 digits long as in online banking systems. It is a one-way function of the challenge; that is, the challenge cannot be inferred from the response, even from several samples of the response, unless the key is known. Where convenient, the smart card 1 may use only portions of the cheque number, for example the last few digits of the cheque number.

In the next step 2026 the smart card 1 causes the card reader 2 to display the response. In the subsequent step 2028, the user writes down the response in the area provided 154 on the cheque 201. The process of writing the cheque 201 is then complete. The user sends or hands the cheque 201 to the intended recipient, the paid party, who can simply cash it manually over the counter of his bank, this is conventional cheque 201 processing and payment, as is well known at present. However, the invention provides that it can also be used for online electronic payment of the cheque as described hereafter.

### Server Payment Computer 500 and Drawee Bank Computer System 300

Referring now to FIG. 4b, the steps undertaken by the paid party according to this embodiment will now be described. In the first step 2102, using an internet client terminal 560 (such as a computer, smartphone or tablet) connected to the Internet 510, the bearer of the cheque (usually the payee (or paid party) but, in some countries, the assignee of the payee) accesses a website hosted by the person-to-person (“P2P”) web server payment computer 500, which is preferably owned and operated by the drawee bank (or, in principle, could be operated by a trusted third party such as an interbank clearing organisation in which the drawee bank participates). The user may already be registered (step 2104) in which case they simply log on in step 2106 with a mobile phone verification code and account verification code (described below).

If not previously registered, then in the next step 2108, the server payment computer 500 transmits a page inviting the payee to enter their name and a mobile phone number, and the account number and the sort code of the payee account and, as security information, their address, date of birth and nationality and the user then transmits the registration data.

In the next step 2110, the server payment computer 500 creates an account record for the payee storing the input information. In the following step 2112, the server payment computer 500 sends a message via the SMS center 600 and the mobile network(s) 610 to the mobile phone 660 identified by the payee, containing a (pseudorandomly generated) mobile phone verification code. In the next step 2114, the server payment computer 500 creates an online payment transaction crediting the identified account with 1 penny (or equivalent minimum value transaction in other currencies) and quoting a (pseudorandomly generated) account verification code. These codes are stored with the account record.

In the following step 2116, the server payment computer 500 sends the payee client terminal 560 a web page informing the user of these transactions and inviting the payee to input the mobile phone verification code and the account verification code.

The payee then checks his mobile phone 660 for the SMS text message, goes online to his bank account and checks the transaction for the transaction code, enters both into the browser on the client terminal 560 and uploads them to the server payment computer 500 in the following step 2118.

The server payment computer 500 checks the codes against those stored in the account record (step 2120). If they do not match and the maximum number of retries (e.g. 3) is exceeded (step 2122), the server payment computer 500 ends the session, otherwise the server payment computer 500 returns to step 2106.

When they do match, the server payment computer 500 prompts the payee to enter the following data from the cheque 201:

Cheque number

Account number of Drawer

Account name

Sort code

Date

Amount

Encrypted hash data

The payee does so (step 2124) and in the next step 2126, the web server payment computer 500 transmits these, and the payee account details, to the drawee bank computer system 300.

In step 3102, the drawee bank computer system 300 checks the drawer record, locates the encryption key associated with the drawer (in some embodiments, the same key may be used for all users) and calculates the encrypted data using the input payment amount and cheque number. If they do not match, the uploaded hash data from the cheque (step 3104) and then the bank computer system 300 sets a transaction error condition (step 3106) and signals it back (step 3108) to the server payment computer 500 (step 2128).

The latter tests whether the maximum number of retries (e.g. 3) has been exceeded (step 2132) and if not, returns to step 2124 to allow the payee to re-input the cheque data, which may have been mis-keyed. Otherwise, the payment process ends (as either the payee is attempting fraud or the drawer has written down the wrong encrypted data on the cheque).

If the hash matches in step 3104, then the bank computer system 300 accesses the account database 320; checks, firstly, whether the cheque number has already been used, and secondly, the drawer's account balance. If the cheque number is that of a cheque which has already been presented in a previous transaction (step 3110), or the requested payment would exceed the balance (taking into account any recorded credit facility) (step 3112), the bank computer system 300 sets a transaction problem condition (step 3114), signals it back (step 3108) to the server payment computer 500 (step 2128), and takes no further action.

The server payment computer 500 then sends an SMS message (step 2134) to the mobile phone 660 of the payee (via the SMS center 600 and the mobile network 610) and, if the server session is still live, displays a corresponding message on the user's browser on the client terminal 560. If the transaction error condition was signalled in step 3108, the SMS message indicates that the payee should consult the payer to rectify a payment problem.

If the cheque number is unused and the payment would not exceed the account balance (steps 3110 and 3112), the server payment computer 500 creates an electronic payment transaction debiting the drawer's account in favour of the payee's bank account (step 3116) which is passed to the payee bank computer system 400 via conventional computerized clearing systems. It then signals a “good transaction” message back (step 3108) to the server payment computer 500 (step 2128).

If the drawer has a mobile phone 650 listed in the customer database 310, the drawee bank computer system 300 sends it a message (via the SMS center 600 and the mobile network 610) indicating that the cheque has been honored, or not handled, in step 3118.

The server payment computer 500 then sends an SMS message to the mobile phone 660 of the payee (via the SMS center 600 and the mobile network 610) and, if the server session is still live, displays a corresponding message on the user's browser on the client terminal 560. It signals the debit to the server payment computer 500, which (step 2134) sends an SMS message to the mobile phone 660 of the payee (via the SMS center 600 and mobile network 610) and, if the server session is still live, displays a corresponding message on the user's browser on the client terminal 560.

At this point, the transaction is complete. Unlike the case where a cheque is cashed over the counter, it remains in the possession of the bearer, but there is no risk that it can be used again as the transaction is recorded at the drawer bank—to show the cheque as stopped. Although the conventional paper-based cheque processing system remains, it has not been used but an electronic transaction has been used instead.

### Second Embodiment

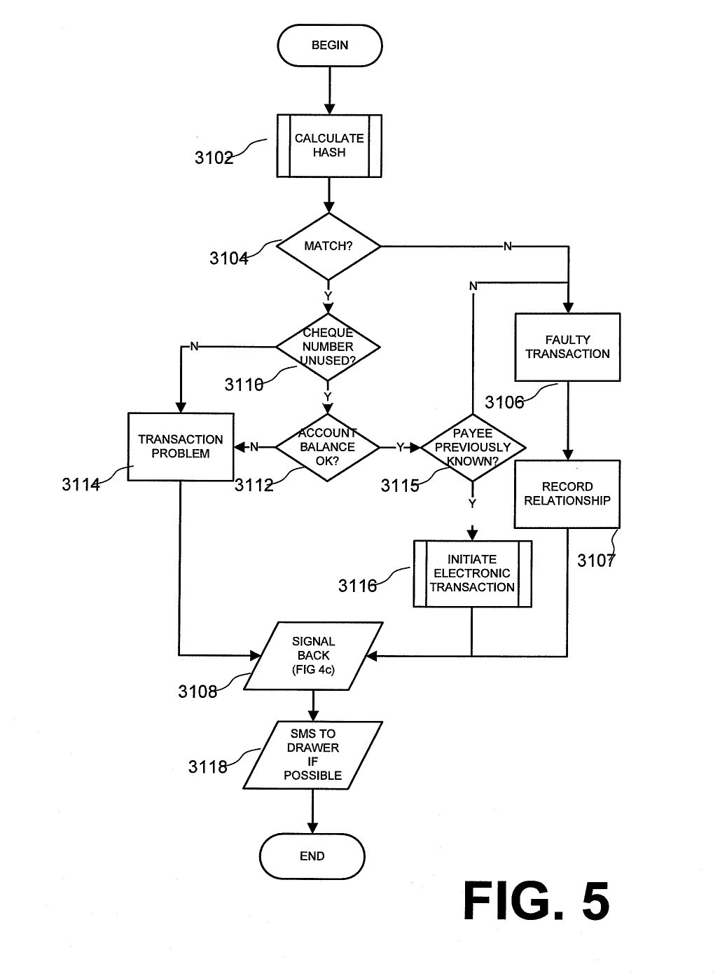

The second embodiment functions in the same manner as the first, except that the processing described in relation to FIG. 4c is replaced by that described in FIG. 5 (in which like-numbered steps are the same as in FIG. 4c and will not be further described). It will be appreciated that in the first embodiment, the bearer of the cheque can deposit the cheque into his account. In some cases, however, it is preferred that the cheque should only be payable to the payee on its face.

Accordingly, in this embodiment, after step 3112 the computer system 300 reviews (step 3115) the records of prior transactions held in the account database 320 for any transactions between the drawer's account (or accounts if the drawer is identified in the customer database 310 as having several) and the payee account details. If they do not match (i.e. if there are no recorded previous cheque transactions, standing orders, direct debits or other transactions between the paid and paying parties), then the transaction is not proceeded with, and the server payment computer 500 signals to the payee's phone 660 via the SMS center 600 and the mobile network 610 to present the cheque over the counter in the conventional fashion. On the other hand, where previous transactions are found, payment is initiated in step 3116 as in the previous embodiment. Preferably, the account database 320 is updated (step 3107) so that next time the payee requests payment from the same person, that relationship will be recognised and the payment will be validated and made to the payee.

Thus, regular payees, such as utility companies or family members, who are presumed to be legitimate payees rather than persons who have stolen the cheque, can use the embodiment to electronically submit cheques. However, new payees must submit their first cheque payment for manual scrutiny by the drawee bank via the usual clearing processes.

### Third Embodiment

This embodiment describes an additional functionality which is preferably provided together with that of the first two embodiments, rather than being used independently thereof, although independent use is also technically possible.

According to this embodiment, the drawer does not use the card reader system 100 and does not write the hashed data 154 on the cheque, but simply writes it in the normal way and supplies it to the sender. Thus, in a transaction according to this embodiment, the process of FIG. 4a is not performed. Referring to FIG. 4b, in this embodiment, steps 2102 to 2124 are performed as described above except that the user does not enter the hashed data 154 from the cheque but merely the six items of cleartext cheque data listed above.

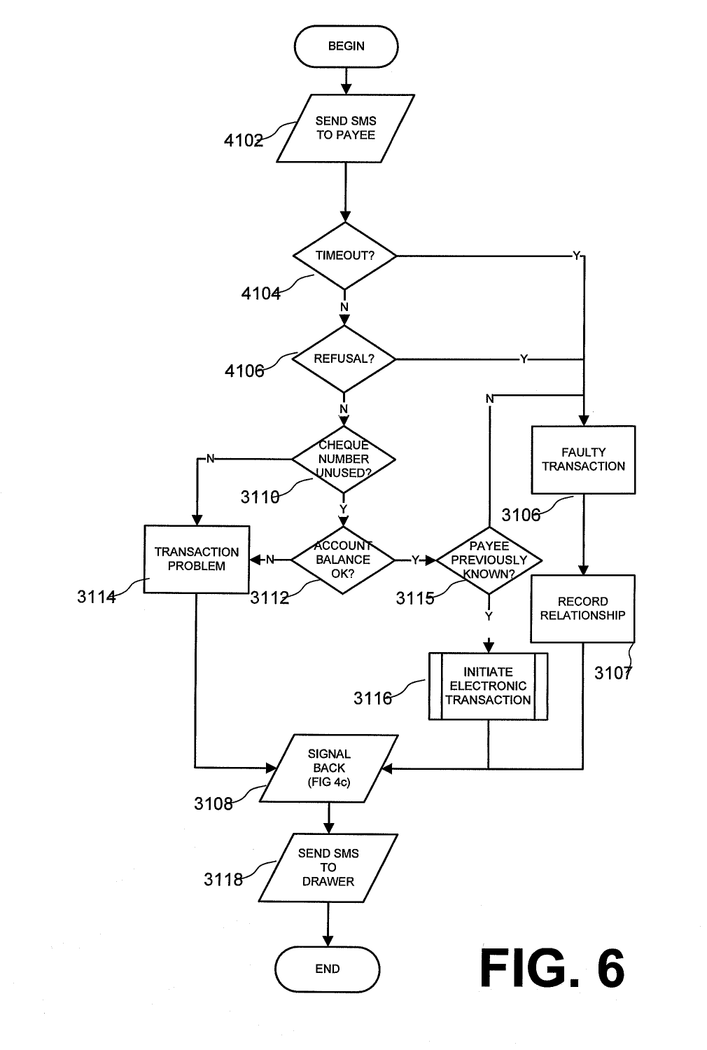

Thus, the bank computer system 300, on receipt of the message in FIG. 6, cannot perform steps 3102-3104 of FIGS. 4c and 5. Instead, if the drawer has a mobile phone 650 listed in the customer database 310, the drawee bank computer system 300 sends it a message (via the SMS center 600 and the mobile network 610) containing the six items of information and asks for a reply message indicating whether the transaction is genuine (step 4102).

If no reply message arrives from the drawer telephone 650 within a predetermined timeout threshold (for example, 48 hours) the bank computer system 300 signals back a faulty transaction to the server payment computer 500 (which then resumes the process of FIG. 4b). Likewise if (step 4104) the reply does not indicate that the transaction is acceptable. The payee is then at liberty to present the cheque at a bank for conventional manual clearing.

If a reply SMS signal from the drawer telephone 650 within the timeout period indicates that the cheque transaction is acceptable, then the drawee bank computer system 300 performs steps 3108-3118 to initiate an electronic payment transaction and accept the cheque as described above, and the server computer performs the corresponding steps of FIG. 4b.

It will be recognised that the communications with the payer mobile phone 540 in this embodiment could be driven by the server payment computer 500 rather than the drawee bank computer system 300.

### Computer Systems

The computer systems and SMS gateway described herein may be implemented by computer systems such as computer system 1000 as shown in FIG. 5. Embodiments of the present invention may be implemented as programmable code for execution by such computer systems 1000. After reading this description, it will become apparent to a person skilled in the art how to implement the invention using other computer systems and/or computer architectures.

Computer system 100Q includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a main memory 1008, preferably random access memory (RAM), and may also include a secondary memory 1010. Secondary memory 1010 includes, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 1018 includes a computer usable storage medium having stored therein computer software and/or data.

In alternative implementations, secondary memory 1010 may include other similar means for allowing computer programs or other instructions to be loaded into computer system 1000. Such means includes, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 also includes a communication interface 1024. Communication interface 1024 allows software and data to be transferred between computer system 1000 and external devices. Examples of communication interface 1024 include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product and loaded into computer system 1000 using removable storage drive 1014, hard disk drive 1012, or communication interface 1024, to provide some examples.

### Alternative Embodiments

Alternative embodiments are possible. Protection is sought for any and all novel subject matter, and combinations thereof, disclosed herein together with all such alternative embodiments apparent to the skilled person, whether or not within the scope of the claims appended hereto.

Alternative embodiments may be implemented as control logic in hardware, firmware, or software or any combination thereof.

1. A computerized payment system for initiating electronic payments based on paper cheques, comprising:
a paying party terminal inputting cleartext data from a cheque issued by a first bank, at which the paying party has an account, and generating therefrom encoded data using a key; and
a first bank computer system associated with the first bank, the first bank computer system accepting, from a paid party, data defining a second bank and an account at the second bank associated with the paid party; the first bank computer system also accepting from the paid party, the input cleartext data from the cheque and the encoded data, and validating the cleartext data from the cheque using the encoded data and the key; and the first bank computer system arranging a transfer from the first bank to the second bank of an amount specified on the cheque.

2. The system according to claim 1, wherein the paying party terminal comprises a card reader, a keyboard for entry of a PIN code and a processor on a card to compare the PIN code with data stored on the card.

3. The system according to claim 1, wherein the cleartext data from the cheque includes a payment amount.

4. The system according to claim 1, wherein the cleartext data from the cheque includes a cheque number.

5. The system according to claim 1, wherein the first bank computer system comprises a web server interface allowing the paid party to communicate electronically therewith.

6. The system according to claim 1, wherein the first bank computer system communicates with a mobile phone of at least one of the parties.

7. The system according to claim 1, further comprising an account database relating to the account of the paying party at the first bank, and the first bank computer system determining therefrom whether there have been previous transactions between the paying party and the paid party to approve the transfer and, if there are no previous transactions, to cease to initiate the transaction.

8. A terminal associated with a paying party in a computerized payment system for initiating electronic payments based on paper cheques, the terminal comprising:
an inputter operable to input cleartext data from a cheque issued by a first bank, at which the paying party has an account; and
a generator operable to generate therefrom encoded data using a key,
whereby the cleartext data from the cheque using the encoded data and the key is validated by a first bank computer system associated with the first bank before the first bank computer system arranges a transfer from the first bank to a second bank of an amount specified on the cheque.

9. A computerized method for initiating electronic payments based on paper cheques, comprising a computer associated with a first bank, and a telephone text messaging center, the computer:
storing telephone numbers of telephones associated with customers;
accepting, from a paid party, data defining a second bank and an account at the second bank associated with the paid party;
accepting, from the paid party, cheque data from a cheque issued by the first bank and drawn by a paying party having an account with the first bank;
sending a message via the telephone text messaging center to a telephone associated with the paying party including the cheque data; and, on receiving an answer message from the telephone confirming the cheque data; and
initiating a transfer from the first bank to the second bank of an amount specified on the cheque.

10. A computer-implemented method of initiating electronic payments based on a paper cheque comprising the steps of:
a payer using a cryptographic device to generate a digital hash from data on the paper cheque;
a payee uploading the payee's bank account details, cheque data and the digital hash to a computer system associated with a bank of the payer;
the computer system associated with the bank of the payer checking the uploaded cheque data using the digital hash and, if the cheque data is valid causing the bank of the payer to initiate an electronic transfer of funds to a bank of the payee.

11. A computer-implemented method of initiating electronic payments based on a paper cheque by:
a payee uploading bank account details of the payee and data from the paper cheque to a computer system associated with a bank of the payer;
the computer system associated with the bank of the payer sending a text message to a phone associated with the payer, the text message including the data from the paper cheque;
the computer system associated with the bank of the payer awaiting a reply text message from the phone; and
on receipt of a valid reply text message, causing the first bank to initiate an electronic transfer of funds to a bank of the payee.

12. A computerized payment system for initiating electronic payments based on paper cheques, comprising:
an issuing bank having a first bank computer system, the first bank computer system includes a client database and an account database;
a payee bank having a second bank computer system, the second bank computer system includes a client databases and an account database;
a server payment computer in communication with the first bank computer system and the second bank computer system;
a drawer card reader system including a smart card and a card reader, wherein upon writing a cheque to a paid party the paying party inserts the smart card into the card reader and proceeds through an authentication process and a response is generated by the drawer card reader system, the response being written on the cheque;
a payee client terminal in communication with the server payment computer, wherein upon the payee internet client terminal uploading data and the response from the cheque to the server payment computer, the first bank computer system determines if the cheque is valid and causes the issuing bank to initiate an electronic transfer of funds to the payee bank if the cheque is confirmed as valid.

13. The system according to claim 12, wherein the drawer card reader includes a keyboard for entry of a PIN code and a processor to compare an authentication code with data stored on the smart card.

14. The system according to claim 12, wherein data from the cheque includes a payment amount.

15. The system according to claim 12, wherein data from the cheque includes a cheque number.

16. The system according to claim 12, wherein the server payment computer comprises a web server interface allowing the paid party to communicate electronically therewith.

17. The system according to claim 16, wherein the server payment computer is connected to an SMS gateway.

18. The system according to claim 12, wherein the web server payment computer communicates with a mobile phone of at least one of the parties.

19. The system according to claim 12, wherein the account database of the first bank computer system determines whether there have been previous transactions between the paying party and the paid party to approve the transfer and, if there are no previous transactions, to cease to initiate the transaction.
